(19) United States
(12) Patent Application Publication
(10) Pub. No.: US 2018/0343553 A1
(43) Pub. Date: Nov. 29, 2018

(54) APPLICATION SYSTEM FOR REMOTE CONTROL, REMOTE CONTROL DEVICE THEREOF, AND PROVIDING METHOD THEREOF

(71) Applicant: BD Inc., Seoul (KR)

(72) Inventor: In Seong HWANG, Seoul (KR)

(21) Appl. No.: 15/550,274

(22) PCT Filed: Feb. 8, 2017
(86) PCT No.: PCT/KR2017/001381

§ 371 Date: Oct. 30, 2017

(30) Foreign Application Priority Data
Feb. 13, 2016 (KR) 10-2016-0016733

(51) Int. Cl. H04W 4/80; H04N 21/40

(52) U.S. Cl. CPC H04W 4/80; H04N 21/40

(57) ABSTRACT

Disclosed are an application system capable of remote control, a remote controller and a control method thereof. The application system capable of remote control includes a signal acquisition module for obtaining a wireless signal output by a remote controller performing wireless communication with the target device, a message acquisition module for obtaining a message set included in the wireless signal from the wireless signal, and a control module controlling a target application corresponding to the message set so that the target application performs an operation corresponding to a command set included in the message set.

### CROSS-REFERENCE TO RELATED APPLICATIONS

This application is the National Stage Entry of International Patent Application No. PCT/KR2017/001381, filed on Feb. 8, 2017, and claims priority from and the benefit of Korean Patent Application No. 10-2016-0016733, filed on Feb. 13, 2016, each of which is incorporated by reference for all purposes as if fully set forth herein.

### BACKGROUND

### Field

The present invention relates to a system and method for enabling a specific operation to be remotely generated in a specific target device (e.g., a smartphone) through short-distance communication with the target device in a relatively short distance.

### Discussion of the Background

There is a need to control a specific target device in a relatively short distance (e.g., several tens of cm˜several tens of m) through short-distance communication.

For example, in the case where the owner of a target device has to perform a series of previously scheduled operations through the target device, if other people can perform at least some of the operations instead of the owner, there may be a very excellent effect in attracting customers into a specific service and the usability of a customer can also be greatly improved.

For example, if a customer who took a meal wants to pay the food expense of the meal, a conventional traditional method is a method for the customer to provide payment means to the restaurant side. However, there is a problem in that a side effect may be present because the occupation of the payment means is temporarily handed over to other people.

Accordingly, it may be necessary for the customer to directly pay the food expense using his or her smart device. In such a case, the customer has to activate his or her smart device, to drive an application capable of paying the corresponding food expense, to receive a check that requests the payment of the food expense from the service provider side through the driven application, and to perform a series of operations necessary for the payment. If a series of such processes are directly performed by the customer, it is very ineffective and inconvenient, thereby making such a method difficult to be substantially commercialized. Furthermore, for such an operation, it is very important to transfer the food expense of the customer to the smart device of the corresponding customer. To this end, there are problems in that the service server side capable of performing communication with the smart device of the customer has to be constructed and a series of information or processes for recognizing the customer (or the smart device of the customer) has to be prepared in the service server.

If the restaurant side electronically directly transfers information related to a check conveniently to the smart device of the customer without asking a series of information for recognizing the customer and the check can be automatically displayed on the smart device, the customer can pay his or her food expense very easily using his or her smart device.

If information or control necessary for a specific device in addition to the payment of food expense as in the aforementioned example can be performed through short-distance communication, a very useful service can be developed.

### SUMMARY

Exemplary embodiments provide a system and method for transferring specific information to a specific device through short-distance communication or controlling an application installed on the specific device using a remote controller.

In accordance with an exemplary embodiment, an application system installed on a target device includes a signal acquisition module for obtaining a wireless signal output by a remote controller performing wireless communication with the target device, a message acquisition module for obtaining a message set included in the wireless signal from the wireless signal, and a control module controlling a target application corresponding to the message set so that the target application performs an operation corresponding to a command set included in the message set.

The control module may control the target application different from the application system, and the message set may include the ID of the target application.

The control module may execute the target application based on the ID of the target application and transfer the command set to the executed target application.

The command set may include a command to be executed by the target application and may further optionally include a command parameter necessary to execute the command.

The command may be a command which loads a specific service page of the target application, and the command parameter may be display information to be displayed in the service page or information necessary to obtain the display information through a specific service server.

The signal acquisition module may obtain the wireless signal through a microphone included in the target device.

The signal acquisition module may wait to receive the wireless signal by controlling the microphone when a specific event is generated by the target device, and terminate a reception standby state if a specific time elapses or when a specific end event is generated by the target device.

The application system of claim 6. The wireless signal may be a frequency signal of a 15,000 Hz˜18,000 Hz band which is capable of being received by the microphone.

The signal acquisition module may obtain the wireless signal from a BLE Bluetooth module included in the target device.

The message set includes one-time authentication information, the application system capable of remote control further includes an authentication module for authenticating the legitimacy of the one-time authentication information, and the control module may control the target application only when the legitimacy of the one-time authentication information is confirmed by the authentication module.

The message set includes the ID information of the remote controller, and the control module may control the target application if the ID information of the remote controller is the ID information of the remote controller previously permitted to control the application system.

The application system capable of remote control may further include a communication module for transmitting a result of an operation of the target application to a specific service server or the remote controller.

An exemplary embodiment provides an application system installed on a target device that includes a signal acquisition module for obtaining a wireless signal output by a remote controller performing wireless communication with the target device and a message acquisition module for obtaining a message set included in the wireless signal from the wireless signal. The signal acquisition module obtains the wireless signal through a microphone included in the target device, waits to receive the wireless signal by controlling the microphone when a specific event is generated by the target device, and terminates a reception standby state if a specific time elapses.

An exemplary embodiment provides an application system installed on a data processing device that includes a signal acquisition module for obtaining a wireless signal output by a remote controller performing wireless communication with the data processing device and a message acquisition module for obtaining information included in the wireless signal from the wireless signal. The signal acquisition module may obtain the wireless signal whose information has been encoded through a microphone included in the data processing device, and the message acquisition module may obtain the information by decoding the wireless signal.

An exemplary embodiment provides a remote controller for controlling an application system installed on a target device that includes a keypad for inputting at least some of messages to be included in a specific message set and a wireless signal output unit for outputting a wireless signal comprising the message set to the target device. The wireless signal is obtained by the application system, and an operation corresponding to a command set included in the message set may be performed by a target application corresponding to the message set.

The message set may include the ID of the target application, and the command set may include a command and a command parameter.

The keypad may include at least one key corresponding to the command or the ID of the target application.

The wireless signal output unit may output a sound wave capable of being received by a microphone included in the target device or may output a BLE Bluetooth wireless signal capable of performing communication with a BLE Bluetooth module included in the target device.

The remote controller may further include an authentication information generation module for generating one-time authentication information to be included in the message set.

The remote controller may further include a communication unit for receiving a result of an operation of the target application from a specific server or from the target device.

An exemplary embodiment provides a remote controller for transmitting specific information to a smartphone that includes a keypad for inputting at least part of the information and a wireless signal output unit for outputting a wireless signal comprising the information to the smartphone. The wireless signal is a sound wave encoded from a message set, and the sound wave is obtained by the smartphone through a microphone included in the smartphone.

An exemplary embodiment provides a method of controlling an application system installed on a target device that includes the steps of obtaining, by the application system, a wireless signal output by a remote controller performing wireless communication with a target device, obtaining, by the application system, a message set included in the wireless signal from the wireless signal, and controlling, by the application system, a target application corresponding to the message set so that the target application performs an operation corresponding to a command set included in the message set.

The step of obtaining, by the application system, the wireless signal output by the remote controller performing wireless communication with the target device may include the step of obtaining, by the application system, the wireless signal through a microphone included in the target device.

The step of obtaining, by the application system, the wireless signal output by the remote controller performing wireless communication with the target device may further include the steps of waiting, by the application system, to receive the wireless signal by controlling the microphone when a specific event is generated by the target device and terminating, by the application system, a reception standby state if a specific time elapses or when a specific end event is generated by the target device.

An exemplary embodiment provides a method of controlling an application system installed on a target device that includes the steps of obtaining, by the application system, a wireless signal output by a remote controller performing wireless communication with a target device and obtaining, by the application system, a message set included in the wireless signal from the wireless signal. The step of obtaining the wireless signal may include a step of obtaining the wireless signal through a microphone included in the target device, and the application system may wait to receive the wireless signal by controlling the microphone when a specific event is generated by the target device and terminates a reception standby state if a specific time elapses.

An exemplary embodiment provides a method of controlling an application system installed on a data processing device that includes the steps of obtaining, by an application system, a wireless signal output by a remote controller performing short-distance wireless communication with the data processing device and obtaining, by the application system, information included in the wireless signal from the wireless signal. The step of obtaining the wireless signal may include the step of obtaining, by the application system, the wireless signal whose information has been encoded through a microphone included in the data processing device, and the step of obtaining the information included in the wireless signal may include the step of obtaining, by the application system, the information by decoding the wireless signal.

An exemplary embodiment provides a method that includes the steps of receiving, by a remote controller, at least some of messages to be included in a specific message set and outputting, by the remote controller, a wireless signal comprising the message set to a target device. The wireless signal is obtained by an application system installed on the target device, and an operation corresponding to a command set included in the message set is performed by a target application corresponding to the message set.

The step of outputting, by the remote controller, the wireless signal comprising the message set to the target device may include the step of outputting a sound wave capable of being received by a microphone included in the target device or outputting a BLE Bluetooth wireless signal capable of performing communication with a BLE Bluetooth module included in the target device.

An exemplary embodiment provides an application control method capable of remote control using a remote controller for transmitting specific information to a smartphone that includes the steps of receiving, by the remote controller, at least part of the information and outputting a wireless signal comprising the information to the smartphone. The wireless signal is a sound wave encoded from a message set, and the sound wave is obtained by the smartphone through a microphone included in the smartphone.

There is provided a computer-readable recording medium on which a program executing the aforementioned method has been recorded.

In accordance with another exemplary embodiment, there is provided a system for restricting the use of software, which is an application system including a processor and memory for storing a computer program executed by the processor, wherein the computer program enables the application system to perform the aforementioned method when it is executed by the processor.

In accordance with an embodiment of the present invention, there is an effect in that a service of a new type can be provided by transferring a series of message sets to a wanted target device through short-distance communication using the remote controller.

Furthermore, there is an effect in that the versatility of a target device to which the technological spirit of the present invention will be applied can be increased because if a wireless signal including a series of message sets can be transferred to a target device through a sound wave, the corresponding target device can be controlled only if a microphone has been provided.

Furthermore, there are effects in that the usability of a service related to a customer can be increased and customers can be greatly attracted accordingly because a series of operations that must be performed by the customer himself(or herself) of a target device can be performed through the remote controller owned by other people, such as an employee.

### BRIEF DESCRIPTION OF DRAWINGS

A brief description of each drawing is provided in order to more fully understand the drawings cited in the detailed description of the present invention.

FIG. 1 is a diagram for illustrating a schematic configuration for implementing a method of controlling an application capable of remote control according to an embodiment of the present invention.

FIG. 2 is a diagram for illustrating a schematic configuration of an application system according to an embodiment of the present invention.

FIG. 3 is a diagram for illustrating a message set according to an embodiment of the present invention.

FIG. 4 is a diagram for illustrating a screen displayed on the target device of a customer according to an embodiment of the present invention.

FIG. 5 is a diagram for illustrating a schematic configuration of a remote controller according to an embodiment of the present invention.

FIG. 6 is a schematic flowchart of a method of controlling an application capable of remote control according to an embodiment of the present invention.

FIG. 7 is a schematic flowchart of a method of controlling an application capable of remote control according to another embodiment of the present invention.

FIG. 8 is a schematic flowchart of a method of controlling an application capable of remote control according to yet another embodiment of the present invention.

### DETAILED DESCRIPTION OF THE ILLUSTRATED EMBODIMENTS

The present invention may be modified in various ways and may have many embodiments. Specific embodiments are to be illustrated in the drawings and are to be described the detailed description. It is however to be understood that the present invention is not intended to be limited to the specific embodiments of the present invention, but that the specific embodiments include all of modifications, equivalents and/or substitutions which fall within the spirit and technological scope of the present invention. In describing the present invention, a detailed description of the known technologies will be omitted if it is deemed to make the gist of the present invention unnecessarily vague.

Terms, such as the first and the second, may be used to describe various elements, but the elements should not be restricted by the terms. The terms are used to only distinguish one element from the other element.

The terms used in this application are used to only describe specific embodiments and are not intended to restrict the present invention. An expression of the singular number includes an expression of the plural number unless clearly defined otherwise in the context.

In this specification, terms, such as “include or “have”, are intended to designate that characteristics, numbers, steps, operations, elements, or parts which are described in the specification, or a combination of them exist, and should not be understood that they exclude the existence or possible addition of one or more other characteristics, numbers, steps, operations, elements, parts, or combinations of them in advance.

Furthermore, in this specification, if one element “sends” data to the other element, this means that one element may directly send the data to the other element or may send the data to the other element through at least another element. In contrast, if one element “directly sends” data to the other element, this means that the data is transmitted from one element to the other element without the intervention of another element.

Hereinafter, the present invention is described in detail based on embodiments of the present invention with reference to the accompanying drawings. The same reference numerals proposed in the drawings denote the same member.

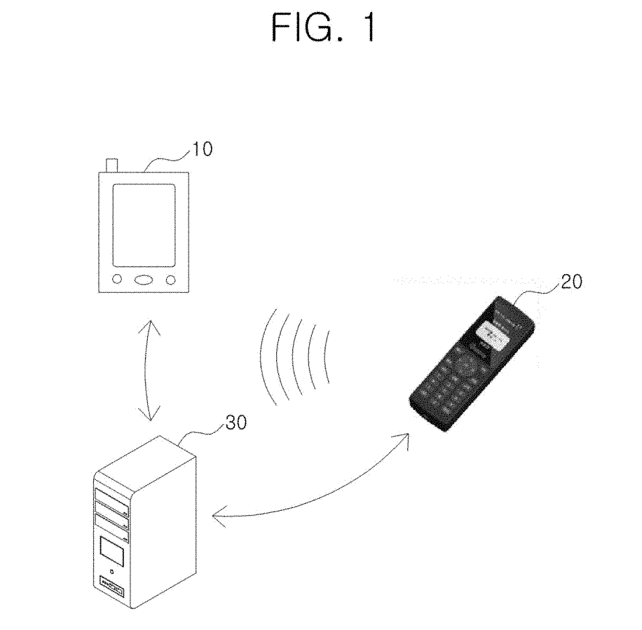

FIG. 1 is a diagram for illustrating a schematic configuration for implementing a method of controlling an application capable of remote control according to an embodiment of the present invention.

Referring to FIG. 1, in order to implement the method of controlling an application capable of remote control according to the technological spirit of the present invention, a remote controller 20 may be provided. The remote controller 20 may control a target device 10 through short-distance communication. To control the target device 10 may mean that specific information is transferred to a specific application (or program) installed on the target device 10 or a specific operation is performed through the application.

In an embodiment of the present invention, the target device 10 is chiefly described as a smartphone or a smart device, but may also be implemented using any data processing device capable of implementing a function defined in this specification. For example, the target device 10 may be a data processing device owned or occupied by a user, such as a smartphone, a tablet PC, a laptop, a desktop, a mobile terminal, a PMP or a PDA.

A specific application system may be installed on the target device 10. The application system may mean a system in which software for implementing the function and operation of the application system and hardware included in the target device 10 are organically combined and implemented. The application system may be implemented by installing the software on the target device 10.

The application system may implement the technological spirit of the present invention by performing communication with a specific service server 30, if necessary.

The service server 30 may perform communication with the application system and/or the remote controller 20 in order to implement the technological spirit of the present invention.

The service server 30 may previously register the ID of a legitimate remote controller to which the technological spirit of the present invention may be applied. Furthermore, the service server 30 may further register a list of application systems and/or target applications which are capable of being controlled for each remote controller. As will be described later, the ID of a remote controller and ID information of an application system and/or a target application to be controlled may be received from the application system connected to the service server 30 using the registered information, whether a corresponding remote controller is a legitimate remote controller may be confirmed and whether the application system and/or the target application may be controlled using the remote controller using the registered information, and a result of the determination may be transferred to the application system. Accordingly, the application system may perform control of the target application based on the received result of the determination.

Furthermore, as will be described later, the service server 30 determines whether one-time authentication information included in a message set from an application system is legitimate and transmits a result of the determination to the application system so that control of a target application is performed only if the one-time authentication information is authenticated.

In accordance with one example, the remote controller 20 may output a wireless signal in order to control the target device 10 or the application system included in the target device 10. An example of the wireless signal may be a sound wave having a specific band. When the remote controller 20 outputs a wireless signal to the target device 10 through such a sound wave, there is an effect in that the technological spirit of the present invention can be applied to the target device 10 if it has only to be a device having sound wave reception means (e.g., a microphone).

In accordance with another embodiment, the wireless signal may be a wireless signal using BLE Bluetooth. As known, BLE Bluetooth has an effect in that it can be applied for the technological spirit of the present invention because paring between two devices can be performed very conveniently and communication between two devices is possible with low power.

The remote controller 20 may approach the target device 10 to be controlled at a relatively short distance (e.g., several tens of cm˜several m) and select a specific device to be controlled by outputting a wireless signal. Accordingly, the remote controller 20 can directly transfer desired information to a desired target device 10.

In accordance with the technological spirit of the present invention, the wireless signal output by the remote controller 20 may include a specific message set. The message set may be a set of information to be transferred to an application system. The application system may perform an operation defined in the message set based on the message set.

Furthermore, in accordance with the technological spirit of the present invention, if a plurality of applications has been installed on the target device 10, an application that belongs to the plurality of applications and that is to be controlled may be selected.

As described above, according to the technological spirit of the present invention, if one target device 10 of unspecified target devices is controlled through short-distance communication, there is an effect in that a series of operations to be performed by the customer of the target device 10 can be performed by the subject that controls the remote controller 20. Furthermore, there is an effect in that service utilization is very high because specific information can be directly transferred at a short distance in the state in which the ID information of a specific device is unknown compared to a case where the service side performs peer-to-peer communication or server-to-client communication in order to transfer the specific information to the specific device.

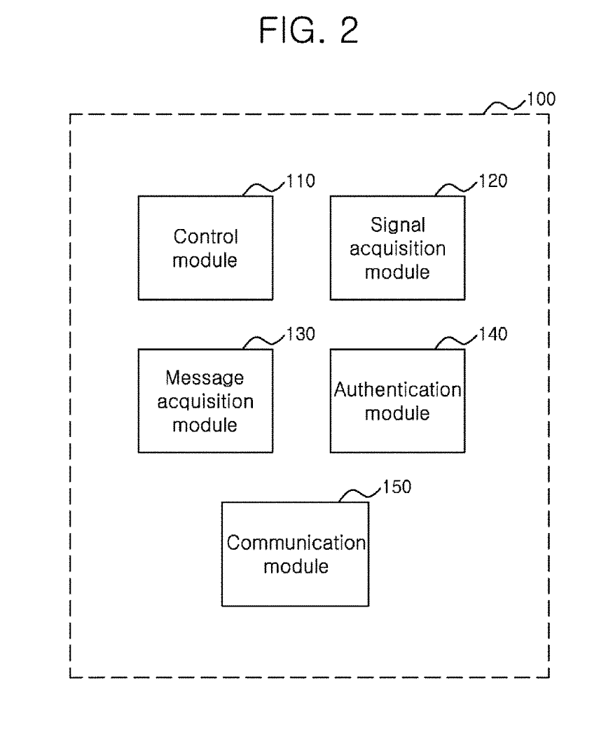

The configuration of the application system installed on the target device 10 in order to implement the technological spirit is described with reference to FIG. 2.

FIG. 2 is a diagram for illustrating a schematic configuration of an application system according to an embodiment of the present invention.

Referring to FIG. 2, the application system capable of remote controller (hereinafter an “application system”) 100 according to an embodiment of the present invention may be implemented in a form in which hardware included in the target device 10 and software driven in the target device 10 are combined.

The application system 100 may include a control module 110, a signal acquisition module 120 and a message acquisition module 130. The application system 100 may further include an authentication module 140 and/or a communication module 150. In some embodiments of the present invention, some of the aforementioned elements may not correspond to element essentially necessary for an implementation of the present invention. Furthermore, in some embodiments, the application system 100 may include elements larger or smaller than the aforementioned elements.

The application system 100 may include hardware resources and/or software necessary to implement the technological spirit of the present invention, but does not essentially mean one physical element or one device. That is, the application system 100 may mean a logical combination of hardware and/or software provided to implement the technological spirit of the present invention, and it may be installed on devices spaced apart from each other, if necessary, to perform respective functions, thereby being capable of implementing a set of logical elements for implementing the technological spirit of the present invention.

Furthermore, in this specification, the module may mean the functional and structural combination of hardware for performing the technological spirit of the present invention and software for driving the hardware. For example, the module may mean a logical unit of specific code and hardware resources in which the specific code is performed. What the module does not mean pieces of code physically connected or one type of piece of hardware may be easily reasoned by an average expert according to the technological field of the present invention.

The control module 110 may control the functions and/or resources of other elements {for example, the signal acquisition module 120, the message acquisition module 130, the authentication module 140 and/or the communication module 150} included in the application system 100.

The signal acquisition module 120 may obtain a wireless signal output by the remote controller 20. The signal acquisition module 120 may obtain a wireless signal in various ways according to some embodiments of a wireless signal. If the wireless signal is a sound wave, the signal acquisition module 120 may obtain the wireless signal through a microphone provided in the target device 10. Furthermore, if the wireless signal is a BLE Bluetooth wireless signal, the signal acquisition module 120 may obtain the wireless signal through a BLE Bluetooth device provided in the target device 10. In some embodiments of other wireless signals, the signal acquisition module 120 may obtain a wireless signal output by the remote controller 20 from a device provided in the target device 10 and capable of receiving the wireless signal.

A message set to be transferred from the subject of control of the remote controller 20 to the application system 100 may have been included in the wireless signal. The message acquisition module 130 may obtain the message set included in the wireless signal. If the wireless signal is a sound wave having a specific frequency band, the message set may be encoded into the wireless signal through a variety of widely known encoding methods. A method of encoding the message set may be performed through frequency modulation, for example. For example, the remote controller 20 may allocate a different frequency to each data bit (e.g., from msb to lsb) corresponding to the message set, and may perform encoding in such a way as to turn on a corresponding frequency if the bit is 1 and to turn off a corresponding frequency if the bit is 0. Such frequencies may be output as the wireless signal. Accordingly, the message acquisition module 130 may obtain the message set by performing decoding using a decoding method corresponding to a method of encoding the message set. For example, the message acquisition module 130 may perform a spectrum analysis for analyzing a frequency component by performing fast Fourier transform (FFT), and may perform decoding for obtaining an encoded bit depending on whether a frequency component allocated to each bit is present.

For example, if the wireless signal is a BLE Bluetooth signal, the message acquisition module 130 may obtain a message set by obtaining a packet corresponding to the message set included in the wireless signal. In this case, the message set may have been encrypted using a specific method. In such a case, the message acquisition module 130 may decrypt the encrypted message set.

When the message acquisition module 130 obtains the message set, the control module 110 may control a target application corresponding to the message set. That is, the target application may be controlled so that an operation corresponding to a command set included in the message set is performed. The target application may be different depending on a message set, and may be a predetermined application, that is, an application corresponding to the application system 100.

That is, the application corresponding to the application system 100 (hereinafter referred to as a “master application”) may control an application different from the master application, that is, a target application, so that the target application performs an operation corresponding to a command set while being executed in background in the target device 10, and the master application itself may perform an operation corresponding to the command set depending on an implementation example.

If the control module 110 controls a target application different from the master application, the ID of a target application capable of identifying the target application may have been included in the message set. An application table in which the ID of a target application and information about the target application corresponding to the ID have been stored may have been stored in the application system 100 or may have been stored in the service server 30 with which the application system 100 can communicate. Accordingly, the control module 110 may specify a target application with reference to the application table when obtaining an ID.

Accordingly, the control module 110 may execute the target application based on the ID of the target application and transfer the command set to the executed target application. To this end, the control module 110 may fetch a specific message or function for executing the target application, and may transfer the command set to the target application as a parameter while fetching the specific message or function.

The command set may include a command and a command parameter. The command may be a command that defines an operation to be executed by the target application. Furthermore, the command parameter may be information (parameter) necessary for the execution of the command. Of course, if such a parameter is not necessary, the command parameter may not be included in the command.

Furthermore, according to an implementation example, control of a target application controlled by the remote controller 20 may be simply the execution of the target application. In such a case, only a command indicting the execution of the target application may be included in the message set.

For example, control of the target application to be performed by the message set may be a specific operation to be performed after the target application is executed (e.g., the execution of a specific service of services provided by the target application). In such a case, the command set may include only a command corresponding to the specific operation.

For example, if necessary information is present while the specific operation is performed, the command set may further include a command parameter.

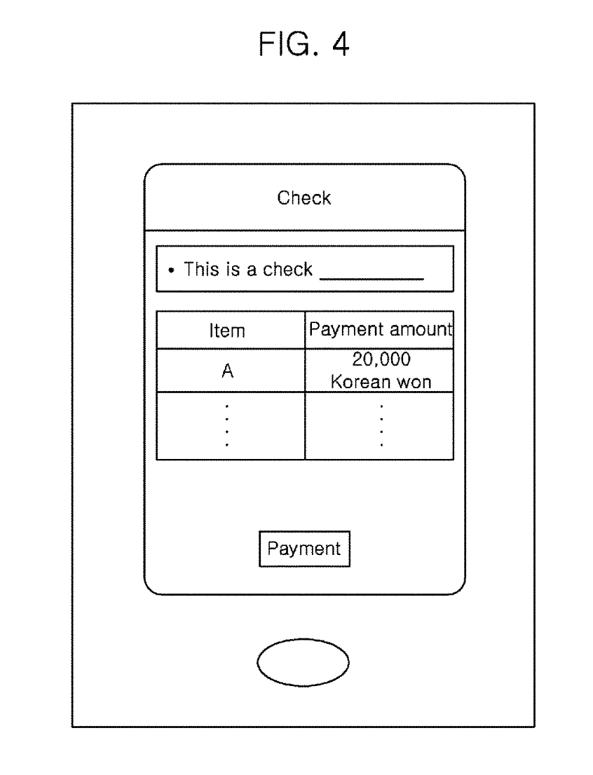

For example, as described above, in the case where a customer wants to pay a food expense in a restaurant, as shown in FIG. 4, the command may be a command that loads a specific service page (e.g., the page of a service that displays a check shown in FIG. 4) of the target application. The command parameter may be display information (e.g., a payment amount (20,000 Korean won) and a payment item A) to be displayed in the service page or is information for specifying the display information.

In such a case, the subject of control (e.g., an employee) of the remote controller 20 may input a command that instructs the customer to display a check and table information (or a calculated amount) through the remote controller 20 to the remote controller 20 through a keypad included in the remote controller 20. Furthermore, after the remote controller 20 is brought close to the target device 10 owned by the customer at a necessary distance, it may output a wireless signal. The wireless signal may include a message set, including the command that instructs the display of the check and the table information (or a calculated amount) as a command parameter. In such a case, the control module 110 may execute a target application in response to the command and enable the target application to execute the command that displays the check. Furthermore, the target application may obtain display information (e.g., a payment amount, a payment item and table ID information) to be included in the check through communication with the service server 30 based on the table information, that is, the command parameter, and may include the obtained display information in the check. Of course, in some embodiments, the command parameter (e.g., a payment amount and a payment item) included in the command set may be the display information itself. In such a case, the target application may include the command parameter itself in the check and display the check. That is, the command parameter may be the display information itself or may be information necessary to obtain the display information through the service server 30.

For example, if a specific point, such as a specific mileage or stamp, is to be saved, the command may be a command corresponding to the saving of the mileage or stamp, and the command parameter may be the amount of a mileage or stamp to be saved.

For example, if an operation for downloading a specific application is necessary, the command may be app download, and the command parameter may be ID information of an application to be downloaded. Of course, the target application may be an application having a function of downloading an application.

In addition, the command and/or the command parameter may be various depending on that the technological spirit of the present invention will be used for which service.

ID information of the command and a command table in which the contents of a command corresponding to the ID information have been defined may have been autonomously stored in the application system 100. The application system 100 may have been stored in the service server 30 capable of communication with the application system 100. Accordingly, when the control module 110 obtains a message set and obtains a command set included in the message set, it may control the target application so that it performs an operation corresponding to the command set using the command table.

If such control is performed, a result of the execution may be fed back to the remote controller 20. To this end, information about a result of the execution of the control operation may be transmitted to the remote controller 20 through the service server 30. To this end, the remote controller 20 may be equipped with a communication device (e.g., a 3G communication chip) capable of performing communication with the service server 30. Accordingly, the subject of control of the remote controller 20 can check the completion of a service to be executed according to the technological spirit of the present invention by checking a result of the execution. Of course, according to an implementation example, if the target device 10 is equipped with a device capable of performing short-distance communication with the remote controller 20, the communication module 150 may directly transmit information about a result of the execution to the remote controller 20 through the device.

Meanwhile, in accordance with the technological spirit of the present invention, the application system 100 may further include an authentication module 140. The authentication module 140 may perform a function of authenticating (legitimacy confirmation) one-time authentication information (OTP) for preventing a reuse attack against a wireless signal or message set if the one-time authentication information is included in the wireless signal. What the authentication module 140 authenticates (legitimacy confirmation) one-time authentication information may mean that it includes a process of receiving a result of authentication from the service server 30 and confirming the one-time authentication information. In order to authenticate the one-time authentication information, the authentication module 140 may directly generate authentication information synchronized with one-time authentication information generated by the remote controller 20. According to an implementation example, authentication information synchronized with one-time authentication information generated by the remote controller 20 may be generated by the service server 30. The authentication module 140 may confirm the legitimacy of one-time authentication information included in the message set through the service server 30. As described above, the control module 110 may control the target application so that it performs an operation corresponding to the message set only when the authentication of one-time authentication information is successful by the authentication module 140.

In accordance with another embodiment, when the service server 30 generates one-time authentication information and sends it to the remote controller 20, the remote controller 20 may include the received one-time authentication information in a message set and transmit the message set to the application system 100. In such a case, the authentication module 140 may transmit the obtained one-time authentication information to the service server 30 and confirm the legitimacy of the one-time authentication information by receiving a result of the authentication from the service server 30. In such a case, there is an effect in that the synchronization of one-time authentication information is not necessary.

The communication module 150 may perform a function of enabling the application system 100 and the service server 30 to perform communication. To this end, the communication module 150 may control a wireless communication device included in the target device 10.

Meanwhile, the message set may further include the ID of the remote controller 20. If the ID of the remote controller 20 is included in the message set, the control module 110 may control a target application only when the ID information of the remote controller corresponds to the application system 100 and/or the ID information of the remote controller corresponds to a target application. The remote controller 20 corresponding to the application system 100 and/or the target application may mean a legitimate remote controller 20 capable of controlling the application system 100 and/or the target application. The legitimate remote controller 20 capable of controlling the application system 100 and/or the target application may be differently set for each application system 100 or may be a remote controller 20 to which legitimacy has been assigned by a legitimate service subject regardless of the application system 100. That is, a legitimate remote controller 20 may be differently defined for each specific target device 10 or for each application system 100 installed on the target device 10. A legitimate remote controller 20 may be defined so that it is used in common regardless of the target device 10 or the application system 100. Of course, in some embodiments, ID information of the application system 100 and/or ID information of a target application which may be controlled may be previously defined for each piece of ID information of a remote controller.

Furthermore, remote controller authentication information, including information about the ID of the remote controller 20 corresponding to the application system 100 and/or a target application (or information about an application system and/or target application which may be controlled for each ID of a remote controller) may be autonomously stored in the application system 100 or may have been stored in the service server 30. The control module 110 confirms whether the ID of the remote controller 20 included in the message set corresponds to the application system 100 and/or the target application based on remote controller authentication information stored in the application system 100 and/or the service server 30. There is an effect in that a case where a remote controller generated by an unjustified attacker attempts to control the application system 100 can be prevented or a case where unlimited use is attempted can be prevented because a limit is set on the application system 100 and/or a target application which may be controlled by the remote controller 20 although a legitimate service subject has been generated.

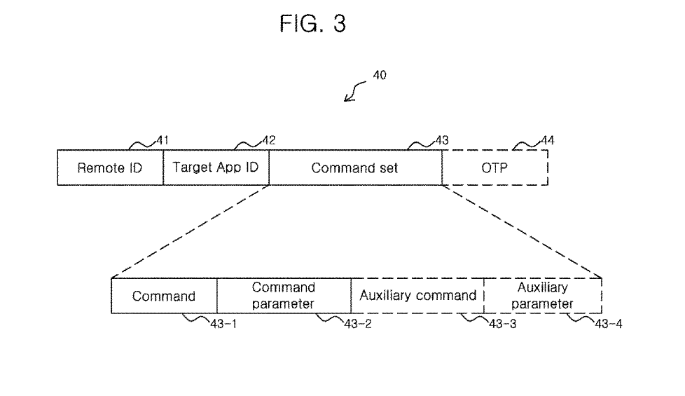

FIG. 3 is a diagram for illustrating a message set according to an embodiment of the present invention.

Referring to FIG. 3, the message set 40 according to an embodiment of the present invention may include a command set 43. The command set 43 may be information for defining an operation to be performed by a target application as described above. The command set 43 may simply define the execution of a target application or may define a process or service to be executed after execution.

The command set 43 may include a command 43-1 as described above. Furthermore, the command set 43 may further include a command parameter 43-2, if necessary. The command parameter 43-2 may specify information necessary to execute the command. Furthermore, the command set 43 may further include an auxiliary command 43-3 and an auxiliary parameter 43-4, if necessary. The auxiliary command 43-3 and the auxiliary parameter 43-4 may be a command capable of selecting a process capable of being selectively performed in a process of performing the command if the process is present and information that specifies information necessary for the process. Accordingly, the auxiliary command 43-3 and the auxiliary parameter 43-4 may be a series of information that may be defined depending on the command. Of course, the command, the command parameter, the auxiliary command and/or the auxiliary parameter included in the message set 40 may be one or plural. For example, if a command that loads a check and the parameter (e.g., table information) of the command are included in a message set, an auxiliary command may be a command that instructs a partitioned check to be loaded, and an auxiliary parameter may be the number of partitions (e.g., the number of persons). In such a case, the application system may load a partition check obtaining by partitioning the check of a specific table according to the number of persons from the target device 10.

Furthermore, the message set 40 may further include the ID 42 of a target application as described above. Furthermore, the message set 40 may further include the ID 41 of a remote controller 20. Furthermore, the message set 40 may further include one-time authentication information (OTP) 44.

Referring back to FIG. 2, according to the technological spirit of the present invention, if the wireless signal output by the remote controller 20 is a sound wave, the signal acquisition module 120 may obtain the wireless signal through a microphone included in the target device 100 as described above.

If the signal acquisition module 120 is adapted to always obtain the right to control the microphone of the target device 10 and to receive a wireless signal any time, there is a problem in that another application provided in the target device 10 cannot obtain a necessary sound wave through the microphone. Furthermore, if the application system 100 waits to receive a sound wave continuously received through the microphone, there are problems in that it unnecessarily obtains an unnecessary sound wave, that is, a sound wave generated in life other than a sound wave output by the remote controller 20, and power consumption of the target device 10 is unnecessarily increased.

Accordingly, the signal acquisition module 120 may wait for the reception of a wireless signal by controlling the microphone only when a specific event is generated by the target device 10. That is, the application system 100 may obtain the right to control the microphone, and the application system 100 may obtain a sound wave received from the microphone. Furthermore, after a lapse of a specific time from the generation of an event, the reception standby state may be terminated. Alternatively, if another application is executed in the target device 10 in the highest layer, the reception standby state may be terminated. In such a case, it is not preferred that the application system 100 has the right to control the microphone even in this state because it may be assumed that a customer attempts to use another application. In addition, various end events (e.g., a lapse of a specific time and/or the execution of another application in the highest layer) may be previously set. When the end event is generated, the application system 100 may terminate the reception standby state.

That is, the right to control the microphone may be released.

If a sound wave output by the remote controller 20 is received within a specific time, control of the target application may be performed as described above. If the sound wave received within the specific time is not a sound wave output by the remote controller 20, the signal acquisition module 120 may neglect the corresponding sound wave and continue to wait for a sound wave output by the remote controller 20.

Furthermore, when the specific time elapses, the signal acquisition module 120 may release the microphone. After the microphone is released, when the remote controller 20 outputs a sound wave, the application system 100 may not obtain the sound wave.

The event may set in various ways. For example, if the target device 10 is a smart device, an operation (e.g., the release of a lock screen and the input of a password) for activating the state of the target device 10 may be the event. Such an event may be an event executed by the owner of the target device 10. Accordingly, the subject of the remote controller 20 may request the customer to execute the event. When the customer executes the event, a sound wave may be output through the remote controller 20 within a specific time.

Accordingly, only if the target device 10 includes a microphone device, versatility in which the technological spirit of the present invention may be applied can be assigned, and a problem generated due to the waiting of a wireless signal unknown to be received when can be solved.

Of course, according to an implementation example of a service, the event may be an operation that should not be executed by a customer, but is automatically performed by the target device 10, and may be set in various ways, if necessary, such as the arrival of a preset time. To this end, the signal acquisition module 120 may be implemented to monitor when such an event is generated in the target device 10.

Furthermore, in accordance with an embodiment, the wireless signal may be a sound wave of a 15,000 Hz˜18,000 Hz band. If the wireless signal is a sound wave of 15,000 Hz˜18,000 Hz band, although the wireless signal is within a range of 20˜20,000 Hz, that is, an audible frequency, but it is a frequency band that may not be easily heard by the human being. Accordingly, there is an effect in that most of people cannot feel unnecessarily noise. Furthermore, there is an advantage in that the wireless signal is a relatively high frequency band within the audible frequency and thus is a frequency band rarely generated in the general life or natural environment. Furthermore, there is an advantage in that the wireless signal is a frequency band from which a signal of high quality can be obtained by most of microphones regardless of their performance in that a microphone included in the target device 10 is commonly provided to obtain a sound wave of an audible frequency band. Furthermore, there is an advantage in that a wireless signal output unit (e.g., an element including a speaker) included in the remote controller 20 can output the frequency band without being greatly influenced by the quality or price of the wireless signal output unit.

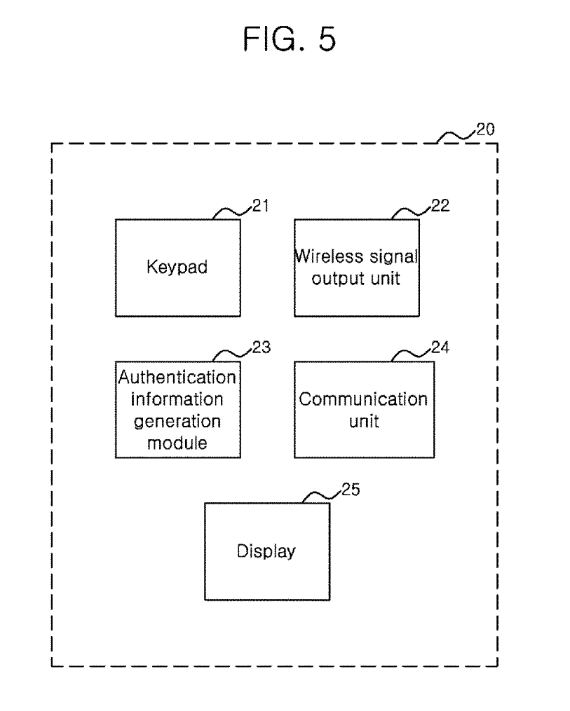

Meanwhile, a schematic configuration of the remote controller 20 for implementing the technological spirit of the present invention is described with reference to FIG. 5.

FIG. 5 is a diagram for illustrating a schematic configuration of the remote controller according to an embodiment of the present invention.

Referring to FIG. 5, the remote controller 20 according to an embodiment of the present invention may include a keypad 21 and a wireless signal output unit 22. The remote controller 20 may further include an authentication information generation module 23, a communication unit 24 and/or a display 25.

The remote controller 20 may be separately fabricated in order to implement the technological spirit of the present invention as shown in FIG. 2. In some embodiments, however, a general-purpose data processing device (e.g., a smartphone) capable of implementing the function of the remote controller 20 defined in this specification may be implemented as the remote controller 20.

The keypad 21 provided in the remote controller 20 may mean an interface through which the subject of control of the remote controller 20 inputs at least some of messages (e.g., a command set, the ID of the remote controller 20, OTP and/or the ID of a target application) to be included in a message set. The subject of control of the remote controller 20 may input all of messages to be included in the message set through the keypad 21, but may input only some messages (e.g., a command set and the ID of a target application) and the remaining some messages (e.g., the ID of the remote controller 20 and OTP) may be automatically included in the message set by the remote controller 20. The keypad 21 may be implemented as a physical keypad. In some embodiments, the keypad 21 may be implemented as a soft keypad displayed on the display 25 according to a process included in the remote controller 20.

Keys for entering a series of numbers may be provided in the keypad 21. According to an implementation example, a key for entering a frequently used target application or command at a time may be provided in the keypad 21.

When a specific key of a plurality of keys provided in the keypad 21 is selected, a key signal corresponding to the selected key may be transferred to the wireless signal output unit 22. The subject of control of the remote controller 20 may input a message to be included in a message set by entering a series of keys. When a wireless signal output key provided in the keypad 21 is entered, a wireless signal generated by the wireless signal output unit 22 may be output.

The wireless signal including the message set may be generated by the wireless signal output unit 22 and output.

The wireless signal output unit 22 may include a specific processor and wireless signal generator included in the remote controller 20. The wireless signal generator may include a speaker capable of generating a sound wave or a device capable of generating a BLE Bluetooth wireless signal according to some embodiments of a wireless signal. Furthermore, the wireless signal generator may generate the message set and include the generated message set in the wireless signal. The message set may be specified by a series of key signals input through the keypad 21, and some message to be included in the message set may have been previously set. Furthermore, if the wireless signal is a sound wave, a specific encoder for encoding the message set into the sound wave may be included in the wireless signal output unit 22.

The wireless signal output by the wireless signal output unit 22 may be obtained by the application system 100 as described above. The message set included in the wireless signal may be obtained by the application system 100. Accordingly, an operation corresponding to a command set included in the message set may be performed by a target application corresponding to the message set.

The message set may include the ID of the target application as described above. The ID of the target application may have been previously set or may be selected through the keypad 21.

Furthermore, the message set may include a command set. The command set may be selected through the keypad 21.

Furthermore, if one-time authentication information is included in the message set, the remote controller 20 may include the authentication information generation module 23 capable of generating the one-time authentication information. When software for generating the one-time authentication information is driven by a processor, the authentication information generation module 23 may be implemented. Synchronized authentication information capable of authenticating the one-time authentication information may be implemented in the application system 100 and may be implemented in the service server 30 as described above. Furthermore, according to an implementation example, the wireless signal output unit 22 may include one-time authentication information, generated by the service server 30 and received from the service server 30, in the message set and output the message set to the target device 10 as described above.

According to an implementation example, although the authentication information generation module 23 is not included in the remote controller 20, one-time authentication information may be included in the message set. In this case, as described above, one-time authentication information may be transmitted from the service server 30 to the remote controller 20. The wireless signal output unit 22 may include the received one-time authentication information in the message set. In such a case, the service server 30 may receive the one-time authentication information through the application system 100, may determine whether the received one-time authentication information is matched up with the one-time authentication information generated by the service server 30 and transmitted to the remote controller 20, and may transfer a result of the determination to the application system 100.

Furthermore, the remote controller 20 may further include the communication unit 24 for performing communication with the service server 30. The communication unit 24 may be implemented as a communication device (e.g., a Wi-Fi or 3G modem) capable of performing wireless communication with the service server 30 as described above. According to an implementation example, the communication device may be implemented to be detachably mounted on the housing of the remote controller 20. In some embodiments, the communication unit 24 may be implemented to perform short-distance communication with the target device 10. In either case, the remote controller 20 may receive a result of the operation of a target application through the communication unit 24.

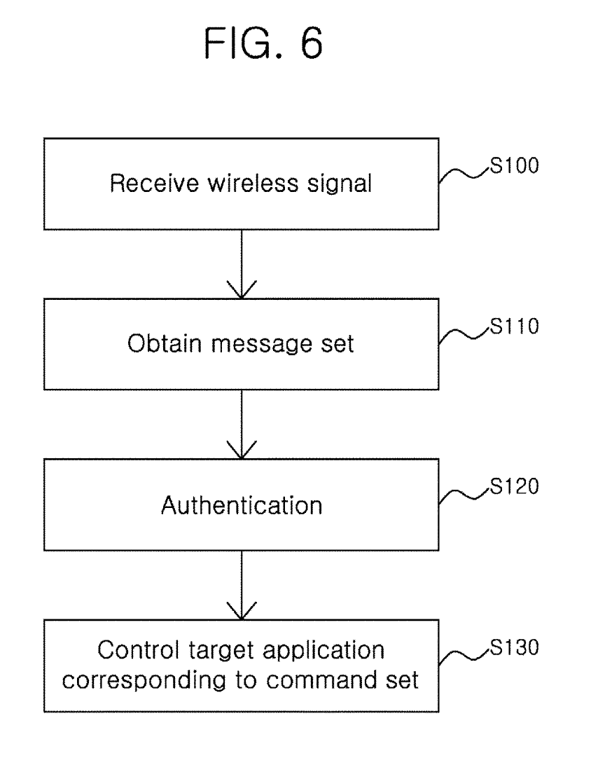

FIG. 6 is a schematic flowchart of a method of controlling an application capable of remote control according to an embodiment of the present invention.

Referring to FIG. 6, for the method of controlling an application capable of remote control according to an embodiment of the present invention, the application system 100 may receive a wireless signal, output by the remote controller 20, from the target device 10 (S100). Furthermore, the application system 100 may obtain a message set included in the wireless signal (S110). If necessary, the application system 100 may experience a specific authentication (S120). The authentication may include authentication through one-time authentication information and/or authentication through the ID of the remote controller 20 as described above.

Furthermore, when the authentication is successful, the application system 100 may control a target application in accordance with a command set included in the message set (S130).

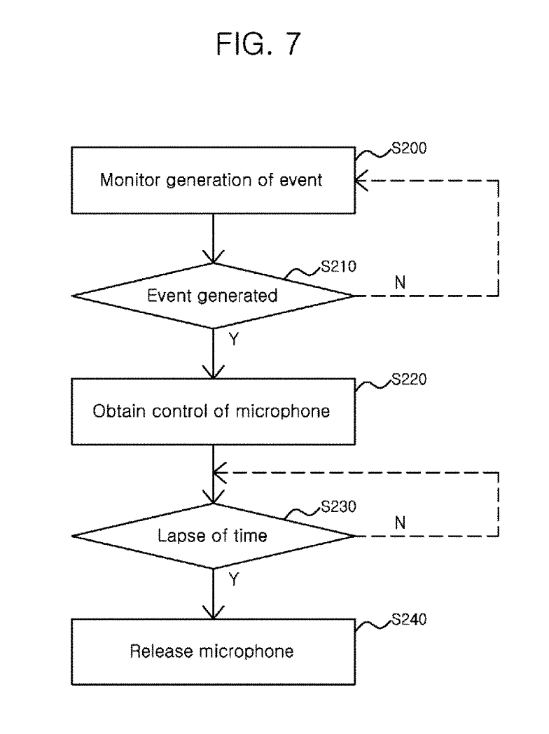

FIG. 7 is a schematic flowchart of a method of controlling an application capable of remote control according to another embodiment of the present invention.

FIG. 7 shows a process of obtaining a wireless signal if the wireless signal is a sound wave according to the technological spirit of the present invention. The application system 100 may monitor whether a specific event is generated by the target device 10 (S200).

Furthermore, when the event is generated (S210), the application system 100 may obtain control of a microphone provided in the target device 10 (S220). That is, the application system 100 may obtain the wireless signal from the microphone. Furthermore, if a specific time elapses after the application system 100 maintains a wireless signal reception standby state in which a sound wave obtained from the microphone is obtained for the specific time (S230), the application system 100 may release the reception standby state by releasing the microphone (S240).

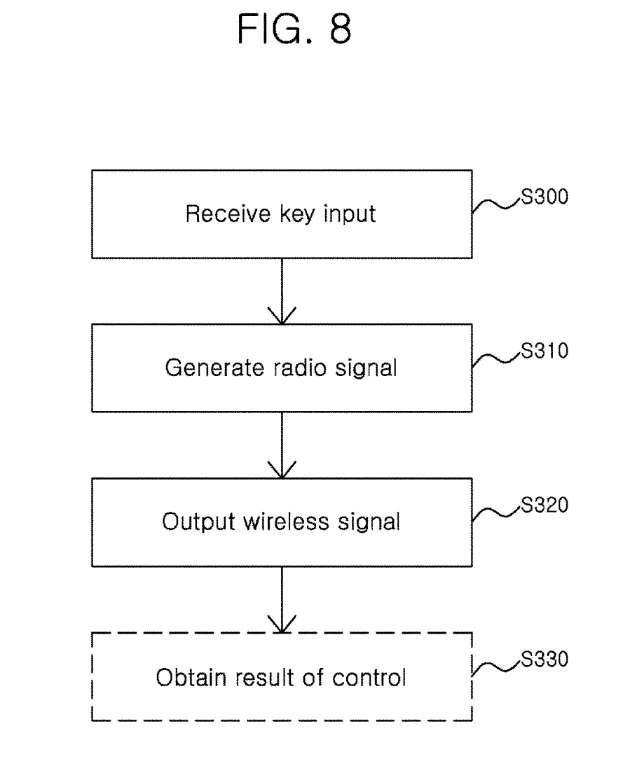

FIG. 8 is a schematic flowchart of a method of controlling an application capable of remote control according to yet another embodiment of the present invention.

Referring to FIG. 8, the remote controller 20 according to the technological spirit of the present invention may receive a key input through the keypad 21 (S300). Furthermore, the remote controller 20 may specify a message set including a message corresponding to the key input, may generate a wireless signal including the message set, and may output the wireless signal (S310, S320). Accordingly, an operation corresponding to the message set may be performed by the target application of the target device 10. The remote controller 20 may obtain a result of the execution from the service server 30 or the target device 10 (S330).

In some implementation examples, the application system 100 may include a processor and memory for storing a program executed by the processor. The processor may include a single core CPU or a multi-core CPU. The memory may include high-speed random access memory, and may include one or more magnetic disk storage devices, flash memory devices or non-volatile memory, such as other non-volatile solid state memory devices. Access to the memory by the processor and other elements may be controlled by a memory controller. In this case, when the program is executed by the processor, it can enable the application system 100 according to the present embodiment to perform the method for providing the system for restricting the use of software.

Meanwhile, the method of controlling an application capable of remote control according to an embodiment of the present invention may be implemented in the form of computer-readable program code and may be stored in a computer-readable recording medium. The computer-readable recording medium includes all of kinds of recording devices in which data readable by a computer system is stored.

The program code recorded on the recording medium may have been specifically designed and configured for the present invention or may have been known to and may be used by those skilled in the software field.

Examples of the computer-readable recording medium include magnetic media such as a hard disk, a floppy disk and a magnetic tape, optical media such as CD-ROM and a DVD, magneto-optical media such as a floptical disk, ROM, RAM, and flash memory, and hardware devices specially configured to store and execute program code. Furthermore, the aforementioned medium may be a transmission medium, such as light including a carrier for sending a signal that designates program code, a data structure, etc., a metal line or a waveguide. Furthermore, the computer-readable recording medium may be distributed to computer systems connected over a network, and the computer-readable code may be stored and executed in a distributed manner.

An example of the program code includes not only machine code, such as that produced by a compiler, but also high-level language code executable by a device for electronically processing information using an interpreter, for example, a computer.

The aforementioned hardware device may be configured to operate as one or more software modules in order to perform the operation of the present invention, and vice versa.

The aforementioned description is illustrative, and those skilled in the art to which the present invention pertains will understand that the present invention may be implemented in other detailed forms without departing from the technological spirit or essential characteristics of the present invention. Accordingly, the aforementioned embodiments should be construed as being only illustrative not as being restrictive from all aspects. For example, each of the elements described in the singular form may be distributed and implemented. Likewise, the elements that have been illustrated as being distributed may also be implemented in a combined form.

The range of right of the present invention is defined by the appended claims rather than the detailed description, and the present invention should be construed as covering all modifications or variations derived from the meaning and scope of the appended claims and their equivalents.

The present invention may be used in an application system capable of remote control, a remote controller, and a method of providing the same.

1. An application system capable of remote control which is installed on a target device, the application system comprising:
a signal acquisition module for obtaining a wireless signal output by a remote controller performing wireless communication with the target device;
a message acquisition module for obtaining a message set included in the wireless signal from the wireless signal; and
a control module controlling a target application corresponding to the message set so that the target application performs an operation corresponding to a command set included in the message set.

2. The application system of claim 1, wherein:
the control module controls the target application different from the application system, and
the message set comprises an ID of the target application.

3. The application system of claim 2, wherein the control module executes the target application based on the ID of the target application and transfers the command set to the executed target application.

4. The application system of claim 1, wherein the command set comprises a command to be executed by the target application and further optionally comprises a command parameter necessary to execute the command.

5. The application system of claim 4, wherein:
the command is a command which loads a specific service page of the target application, and
the command parameter is display information to be displayed in the service page or information necessary to obtain the display information through a specific service server.

6. The application system of claim 1, wherein the signal acquisition module obtains the wireless signal through a microphone included in the target device.

7. The application system of claim 6, wherein the signal acquisition module waits to receive the wireless signal by controlling the microphone when a specific event is generated by the target device, and terminates a reception standby state if a specific time elapses or when a specific end event is generated by the target device.

8. The application system of claim 6, wherein the wireless signal is a frequency signal of a 15,000 Hz˜18,000 Hz band which is capable of being received by the microphone.

9. The application system of claim 1, wherein the signal acquisition module obtains the wireless signal from a BLE Bluetooth module included in the target device.

10. The application system of claim 1, wherein:
the message set comprises one-time authentication information,
the application system capable of remote control further comprises an authentication module for authenticating a legitimacy of the one-time authentication information, and
the control module controls the target application only when the legitimacy of the one-time authentication information is confirmed by the authentication module.

11. The application system of claim 1, wherein:
the message set comprises ID information of the remote controller, and
the control module controls the target application if the ID information of the remote controller is ID information of the remote controller previously permitted to control the application system.

12. The application system of claim 1, wherein the application system capable of remote control further comprises a communication module for transmitting a result of an operation of the target application to a specific service server or the remote controller.

13. An application system capable of remote control which is installed on a target device, the application system comprising:
a signal acquisition module for obtaining a wireless signal output by a remote controller performing wireless communication with the target device; and
a message acquisition module for obtaining a message set included in the wireless signal from the wireless signal,
wherein the signal acquisition module obtains the wireless signal through a microphone included in the target device, waits to receive the wireless signal by controlling the microphone when a specific event is generated by the target device, and terminates a reception standby state if a specific time elapses or when a specific end event is generated by the target device.

14. (canceled)

15. A remote controller for controlling an application system installed on a target device, the remote controller comprising:
a keypad for inputting at least some of messages to be included in a specific message set; and
a wireless signal output unit for outputting a wireless signal comprising the message set to the target device,
wherein the wireless signal is obtained by the application system, and an operation corresponding to a command set included in the message set is performed by a target application corresponding to the message set.

16. The remote controller of claim 15, wherein the message set comprises an ID of the target application.

17. The remote controller of claim 15, wherein the command set comprises a command and a command parameter.

18. The remote controller of claim 17, wherein the keypad comprises at least one key corresponding to the command or an ID of the target application.

19. The remote controller of claim 15, wherein the wireless signal output unit outputs a sound wave capable of being received by a microphone included in the target device or outputs a BLE Bluetooth wireless signal capable of performing communication with a BLE Bluetooth module included in the target device.

20. The remote controller of claim 15, wherein the remote controller further comprises an authentication information generation module for generating one-time authentication information to be included in the message set.

21. The remote controller of claim 15, wherein the remote controller further comprises a communication unit for receiving a result of an operation of the target application from a specific server or from the target device.

22-32. (canceled)
